(19) United States
(12) Patent Application Publication
(10) Pub. No.: US 2021/0174270 A1
(43) Pub. Date: Jun. 10, 2021

(54) RIDESHARE VEHICLE DEMAND FORECASTING DEVICE, METHOD FOR FORECASTING RIDESHARE VEHICLE DEMAND, AND STORAGE MEDIUM

(71) Applicants: Kabushiki Kaisha Toshiba, Tokyo (JP); Toshiba Digital Solutions Corporation, Kawasaki-shi (JP)

(72) Inventors: Yuuji IRIMOTO, Fussa (JP); Hiroki UEDA, Suginami (JP); Hiroyuki ITAKURA, Fuchu (JP); Hidemasa ITOU, Inagi (JP); Shinichi KASHIMOTO, Chuo (JP)

(73) Assignees: Kabushiki Kaisha Toshiba, Tokyo (JP); Toshiba Digital Solutions Corporation, Kawasaki-shi (JP)

(21) Appl. No.: 17/181,330

(22) Filed: Feb. 22, 2021

Related U.S. Application Data
(63) Continuation of application No. PCT/JP2019/028937, filed on Jul. 24, 2019.

(30) Foreign Application Priority Data
Aug. 24, 2018 (JP) 2018-157045

(51) Int. Cl. G06Q 10/04; G06Q 10/02; G06Q 50/30; G06N 3/04

(52) U.S. Cl. CPC G06Q 10/04; G06N 3/04; G06Q 50/30; G06Q 10/02

(57) ABSTRACT

A rideshare vehicle demand forecasting device of an embodiment includes a processor. The processor acquires a reservation forecast number, which corresponds to a number of reservations each of which is capable of being established in future as a reservation for boarding/exiting a rideshare vehicle within a plurality of predetermined areas, at predetermined intervals by using a model including a neural network that is caused to perform machine learning by using, as input data, reservation data indicating a reservation situation at a time of establishment of the reservation for the rideshare vehicle, movement data indicating an area where an end user actually boards/exits the rideshare vehicle on an operation day of the rideshare vehicle, and boarding/exiting factor data containing data that are capable of becoming a factor for an occurrence of boarding/exiting of the end user on the operation day of the rideshare vehicle.

### CROSS REFERENCE TO RELATED APPLICATION

This application is a continuation application of PCT/JP2019/028937 filed on Jul. 24, 2019 and claims benefit of Japanese Application No. 2018-157045 filed in Japan on Aug. 24, 2018, the entire contents of which are incorporated herein by this reference.

### BACKGROUND OF THE INVENTION

### 1. Field of the Invention

An embodiment relates to a rideshare vehicle demand forecasting device, a method for forecasting rideshare vehicle demand, and a storage medium.

### 2. Description of the Related Art

In recent years, an on-demand traffic service has been utilized where an operation schedule is set by reflecting reservations made by end users, and rideshare vehicles are dispatched based on the operation schedule.

In the on-demand traffic service, it is necessary to set a stop point and an operation route for the rideshare vehicle such that it is possible to prevent the occurrence of a delay from a departure/arrival time set in the operation schedule. Therefore, in the on-demand traffic service, there is a demand to keep the departure/arrival time decided in advance, and to forecast demand in order to efficiently dispatch rideshare vehicles.

However, a conventionally known method has a problem that the above-mentioned demand forecasting cannot be performed with high accuracy.

### BRIEF DESCRIPTION OF THE DRAWINGS

FIG. 1 is a view showing one example of a configuration of a traffic service system including a demand forecasting server according to an embodiment;

FIG. 2 is a view showing one example of matrix data contained in reservation data;

FIG. 3 is a view showing one example of matrix data contained in accumulated movement data;

FIG. 4 is a view showing one example of a configuration of the demand forecasting server according to the embodiment;

FIG. 5 is a view for describing one example of a configuration of a rideshare demand forecasting program used in processing of the demand forecasting server according to the embodiment;

FIG. 6 is a conceptual view for describing one example of a boarding/exiting demand number forecast model contained in the rideshare demand forecasting program;

FIG. 7 is a flowchart showing one example of processing performed by the demand forecasting server according to the embodiment; and

FIG. 8 is a view for describing a specific example of a demand forecast screen.

### DETAILED DESCRIPTION OF THE PREFERRED EMBODIMENTS

A rideshare vehicle demand forecasting device of an embodiment is a device for forecasting demand for a rideshare vehicle that is operated according to an operation schedule set by reflecting a reservation made by an end user, and that is operated within a plurality of predetermined areas, and the rideshare vehicle demand forecasting device is configured to include a processor. The processor is configured to acquire a reservation forecast number, which corresponds to a number of reservations each of which is capable of being established in future as a reservation for boarding/exiting the rideshare vehicle within the plurality of predetermined areas, at predetermined intervals by using a model including a neural network that is caused to perform machine learning by using, as input data, reservation data indicating a reservation situation at a time of establishment of the reservation for the rideshare vehicle, movement data indicating an area where the end user actually boards/exits the rideshare vehicle on an operation day of the rideshare vehicle, and boarding/exiting factor data containing data that are capable of becoming a factor for an occurrence of boarding/exiting of the end user on the operation day of the rideshare vehicle.

Hereinafter, the embodiment will be described with reference to drawings.

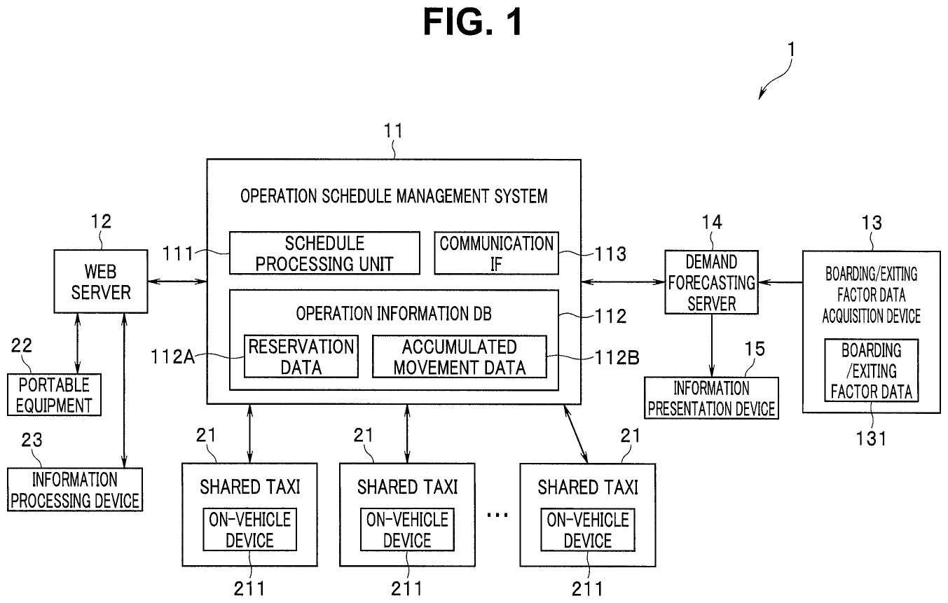

As shown in FIG. 1, a traffic service system 1 is configured to include an operation schedule management system 11, a web server 12, a boarding/exiting factor data acquisition device 13, a demand forecasting server 14, and an information presentation device 15. FIG. 1 is a view showing one example of the configuration of the traffic service system including the demand forecasting server according to the embodiment.

The operation schedule management system 11 is configured to include a processor and a memory, for example. The operation schedule management system 11 is also configured to include a schedule processing unit 111, an operation information DB (database) 112, and a communication IF (interface) 113.

The schedule processing unit 111 is configured to read reservation data 112A, stored in the operation information DB 112, in response to a reservation inquiry request received via the web server 12, and to perform an action for causing the read reservation data 112A (described later) to be sent from the communication IF 113 to the web server 12.

The schedule processing unit 111 is configured to perform processing for setting estimated departure/arrival information in response to a reservation execution request received via the web server 12 by referring to the reservation data 112A stored in the operation information DB 112. The estimated departure/arrival information contains an estimated departure time, which corresponds to a desired boarding point and a desired boarding time for a shared taxi 21 which are contained in the reservation execution request, and an estimated arrival time, which corresponds to a desired exiting point and a desired exiting time for the shared taxi 21 which are contained in the reservation execution request. The schedule processing unit 111 is also configured to perform an action for causing the estimated departure/arrival information which is set as described above to be sent from the communication IF 113 to the web server 12.

The schedule processing unit 111 is configured as follows. When the schedule processing unit 111 detects that the estimated departure time and the estimated arrival time contained in the estimated departure/arrival information are not approved based on reservation confirmation information, which is received via the web server 12 after the estimated departure/arrival information is sent in response to the reservation execution request, the schedule processing unit 111 determines that a reservation corresponding to the estimated departure/arrival information is not established, and discards the reservation execution request and the estimated departure/arrival information.

The schedule processing unit 111 is configured as follows. When the schedule processing unit 111 detects that the estimated departure time and the estimated arrival time contained in the estimated departure/arrival information are approved based on the reservation confirmation information, which is received via the web server 12 after the estimated departure/arrival information is sent in response to the reservation execution request, the schedule processing unit 111 determines that the reservation corresponding to the estimated departure/arrival information is established. Then, the schedule processing unit 111 performs processing for identifying a desired boarding area, where a desired boarding point contained in the reservation execution request is present, and a desired exiting area, where a desired exiting point contained in the reservation execution request is present, from a plurality of predetermined areas included in an operation area of the shared taxis 21. The schedule processing unit 111 is also configured to perform processing for generating reservation management information where the desired boarding point and the desired exiting point, contained in the reservation execution request at the time of the establishment of the reservation, the desired boarding area and the desired exiting area, identified based on the reservation execution request, and the estimated departure/arrival information, set based on the reservation execution request, are associated with each other. The schedule processing unit 111 is also configured to perform processing for updating the reservation data 112A, stored in the operation information DB 112, by using the reservation management information generated as described above, and to perform an action for causing the updated reservation data 112A to be sent from the communication IF 113 to the demand forecasting server 14 at predetermined intervals (at five-minute intervals, for example).

The schedule processing unit 111 is configured to perform processing for setting an operation schedule based on the reservation data 112A, rideshare demand forecast data 143B (described later) received from the demand forecasting server 14, and GPS data received from one or more shared taxis 21 in operation. The schedule processing unit 111 is also configured to perform an action for causing the operation schedule which is set as described above to be sent from the communication IF 113 to the shared taxis 21.

For example, the above-mentioned GPS data are received by an on-vehicle device 211 provided to each shared taxi 21 by wireless communication, and are sent from the on-vehicle device 211 to the operation schedule management system 11 by wireless communication.

The on-vehicle device 211 is provided with a wireless communication unit (not shown in the drawing) having a function of receiving GPS data sent from a GPS satellite, a function of sending the GPS data to the operation schedule management system 11, and a function of receiving an operation schedule sent from the operation schedule management system 11, for example. The on-vehicle device 211 is also provided with a display unit (not shown in the drawing) having a function of displaying the operation schedule received from the operation schedule management system 11, for example.

The schedule processing unit 111 is configured to identify the areas where boarding/exiting of a passenger actually occurs on the operation day of the shared taxis 21 from the plurality of predetermined areas included in the operation area of the shared taxis 21 based on map data for the operation area of the shared taxis 21 and the GPS data received from the shared taxis 21, and to perform processing for generating operation management information indicating the identified area.

The map data for the operation area of the shared taxis 21 may be data stored in advance in the operation information DB 112, or may be data acquired from a map service on the Internet, for example.

The schedule processing unit 111 is configured to perform processing for updating accumulated movement data 112B (described later), which are stored in the operation information DB 112, using the operation management information generated as described above, and to perform an action for causing the updated accumulated movement data 112B to be sent from the communication IF 113 to the demand forecasting server 14 at predetermined intervals (at five-minute intervals, for example). In other words, the schedule processing unit 111 is configured to perform an action for causing the reservation data 112A and the accumulated movement data 112B to be sent from the communication IF 113 to the demand forecasting server 14 at predetermined intervals.

The operation information DB 112 stores the reservation data 112A and the accumulated movement data 112B. In the present embodiment, the operation information DB 112 may be provided in an external file server (also including a cloud-based file server) of the operation schedule management system 11.

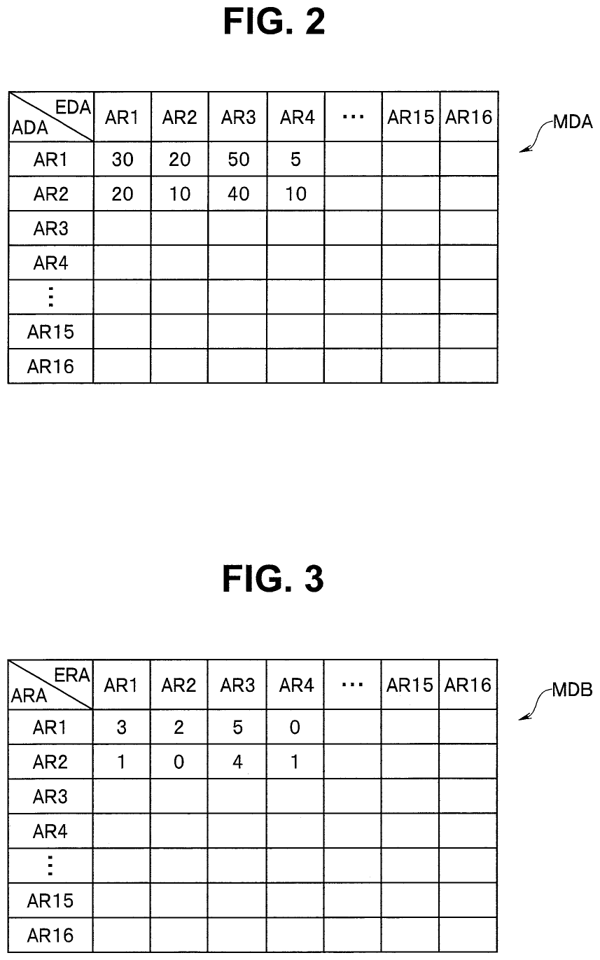

The reservation data 112A contain, for example, matrix data MDA shown in FIG. 2 as data that correspond to the reservation management information generated by the schedule processing unit 111. FIG. 2 is a view showing one example of matrix data contained in reservation data.

The matrix data MDA are configured as data representing the frequency of occurrences of each combination of a desired boarding area EDA and a desired exiting area ADA identified from the reservation execution request at the time of the establishment of the reservation.

The matrix data MDA in FIG. 2 are configured as data in the case where both the desired boarding area EDA and the desired exiting area ADA include sixteen areas ranging from an area AR1 to an area AR16. In other words, the matrix data MDA in FIG. 2 are configured as data representing the frequency of occurrences of each of 256 combinations of the desired boarding area EDA and the desired exiting area ADA.

For example, the matrix data MDA in FIG. 2 show that a reservation, where each of both the desired boarding area EDA and the desired exiting area ADA is the area AR1 (boarding and exiting in the area AR1 are desired) of the sixteen areas of the area AR1 to the area AR16 included in the operation area of the shared taxis 21, is established 30 times. For example, the matrix data MDA in FIG. 2 also show that a reservation, where the desired boarding area EDA is the area AR1, and the desired exiting area ADA is an area AR2 (boarding in the area AR1 and exiting in the area AR2 are desired) of the sixteen areas of the area AR1 to the area AR16 included in the operation area of the shared taxis 21, is established 20 times.

Assuming that the time at which data are updated last by the schedule processing unit 111 is a time TN, for example, it is sufficient that the matrix data MDA in FIG. 2 contain the number of reservations established before a time TP, which is a time traced back from the time TN by a predetermined number of days.

The accumulated movement data 112B contain, for example, matrix data MDB shown in FIG. 3 as data that correspond to the operation management information generated by the schedule processing unit 111. FIG. 3 is a view showing one example of matrix data contained in the accumulated movement data.

The matrix data MDB are configured as data representing the frequency of occurrences of each combination of a boarding occurrence area ERA and an exiting occurrence area ARA, the boarding occurrence area ERA corresponding to the area where one or more end users actually board the shared taxi 21 on the operation day of the shared taxis 21, the exiting occurrence area ARA corresponding to the area where one or more end users actually exit the shared taxi 21 on the operation day of the shared taxis 21. The matrix data MDB are configured as data representing boarding/exiting records for one day on the operation day of the shared taxis 21. Therefore, in the present embodiment, each time 24 hours elapse, for example, new matrix data MDB are generated where the frequency of occurrences of each combination of the boarding occurrence area ERA and the exiting occurrence area ARA is reset to zero.

The matrix data MDB in FIG. 3 are configured as data in the case where each of the boarding occurrence area ERA and the exiting occurrence area ARA includes sixteen areas of the area AR1 to the area AR16. In other words, the matrix data MDB in FIG. 3 are configured as data representing the frequency of occurrences of each of 256 combinations of the boarding occurrence area ERA and the exiting occurrence area ARA.

For example, the matrix data MDB in FIG. 3 show that the movement of the shared taxi 21 where each of both the boarding occurrence area ERA and the exiting occurrence area ARA is the area AR1 (boarding and exiting occur in the area AR1) of the sixteen areas of the area AR1 to the area AR16 included in the operation area of the shared taxis 21 is performed three times. For example, the matrix data MDB in FIG. 3 also show that the movement of the shared taxi 21 where the boarding occurrence area ERA is the area AR1, and the exiting occurrence area ARA is the area AR2 (the boarding occurs in the area AR1, and the exiting occurs in the area AR2) of the sixteen areas of the area AR1 to the area AR16 included in the operation area of the shared taxis 21 is performed twice.

For example, the communication IF 113 is configured to include a communication unit that is connectable to a network, such as the Internet, to enable wired or wireless communication with the web server 12 and the demand forecasting server 14. Further, the communication IF 113 is configured to be able to achieve wireless communication with the shared taxis 21 (the on-vehicle devices 211).

The web server 12 is configured to include a processor, a memory, and a communication unit, for example.

The web server 12 is configured to perform an action for sending data or the like used for a GUI (graphical user interface) display of website (hereinafter referred to as “taxi reservation site”) relating to a reservation for a shared taxi in response to an access request from portable equipment 22, which corresponds to a smartphone, a tablet terminal or the like controlled by an end user. The web server 12 is also configured to perform an action for sending data or the like used for the GUI display of the taxi reservation site in response to an access request from an information processing device 23, which corresponds to a personal computer or the like controlled by a dispatcher who receives telephone communication from end users.

The web server 12 is configured as follows. When the web server 12 detects that a reservation inquiry request is made to browse a current reservation situation for shared taxis in the taxi reservation site displayed on the portable equipment 22 or the information processing device 23, the web server 12 performs an action for sending the reservation inquiry request to the operation schedule management system 11. The web server 12 is also configured to generate data on the reservation inquiry results used to display information indicating the current reservation situation for the shared taxis based on the reservation data 112A received from the operation schedule management system 11 after the reservation inquiry request is sent, and to perform an action for sending the generated data on the reservation inquiry results to the portable equipment 22 or the information processing device 23 by which the reservation inquiry request is made.

The web server 12 is configured as follows. When the web server 12 detects that a reservation execution request is made in a state where information of a desired boarding point, a desired boarding time, a desired exiting point, and a desired exiting time that corresponds to information necessary for making a reservation for a shared taxi is inputted in the taxi reservation site displayed on the portable equipment 22 or the information processing device 23, the web server 12 performs an action for sending the reservation execution request containing the inputted information to the operation schedule management system 11. The web server 12 is also configured to generate estimated departure/arrival confirmation data used to display information for promoting selection relating to whether or not an estimated departure time and an estimated arrival time contained in the estimated departure/arrival information are approved based on the estimated departure/arrival information received from the operation schedule management system 11 after the reservation execution request is sent, and to perform an action for sending the generated estimated departure/arrival confirmation data to the portable equipment 22 or the information processing device 23 by which the reservation execution request is made. The web server 12 is also configured to receive reservation confirmation information from the portable equipment 22 or the information processing device 23. Whether or not the estimated departure time and the estimated arrival time used at the time of generating the estimated departure/arrival confirmation data and contained in the estimated departure/arrival information are approved by an end user can be specified based on the reservation confirmation information. The web server 12 is also configured to perform an action for sending the received reservation confirmation information to the operation schedule management system 11.

The boarding/exiting factor data acquisition device 13 is configured to include a processor, a memory, and a communication unit, for example. Further, the boarding/exiting factor data acquisition device 13 is configured to acquire boarding/exiting factor data 131 at arbitrary timing, and to send the acquired boarding/exiting factor data 131 to the demand forecasting server 14 at predetermined intervals (at five-minute intervals, for example).

The boarding/exiting factor data 131 contain data that are capable of becoming a factor for an occurrence of boarding/exiting of an end user on the operation day of the shared taxis 21 as data that can be utilized in processing performed by the demand forecasting server 14.

More specifically, the boarding/exiting factor data 131 contain, for example, weather data formed of two pieces of data, that is, data indicating whether or not the weather in the operation area of the shared taxis 21 on the operation day is sunny, and data indicating whether or not the weather in the operation area of the shared taxis 21 on the operation day is rainy. The boarding/exiting factor data 131 also contain, for example, temperature data formed of two pieces of data, that is, data indicating whether or not a temperature in the operation area of the shared taxis 21 on the operation day corresponds to a high temperature, and data indicating whether or not the temperature in the operation area of the shared taxis 21 on the operation day corresponds to a low temperature. The boarding/exiting factor data 131 also contain, for example, date data containing data indicating whether or not the date of the operation day of the shared taxis 21 is a weekday, and data indicating whether or not the date of the operation day of the shared taxis 21 is a holiday.

In other words, the boarding/exiting factor data 131 contain data indicating the weather in the plurality of predetermined areas included in the operation area of the shared taxis 21, data indicating temperatures in the plurality of predetermined areas, and data indicating the date of the operation day of the shared taxis 21.

In the present embodiment, data other than weather data, temperature data, and date data may be contained in the boarding/exiting factor data 131. More specifically, in the present embodiment, the boarding/exiting factor data 131 may contain traffic obstacle data indicting presence or absence of an occurrence of traffic obstacles (accident, congestion, disaster, and the like) in each area included in the operation area of the shared taxis 21, for example. Further, in the present embodiment, the boarding/exiting factor data 131 may contain average age data indicating the average age of end users in each area included in the operation area of the shared taxis 21, for example.

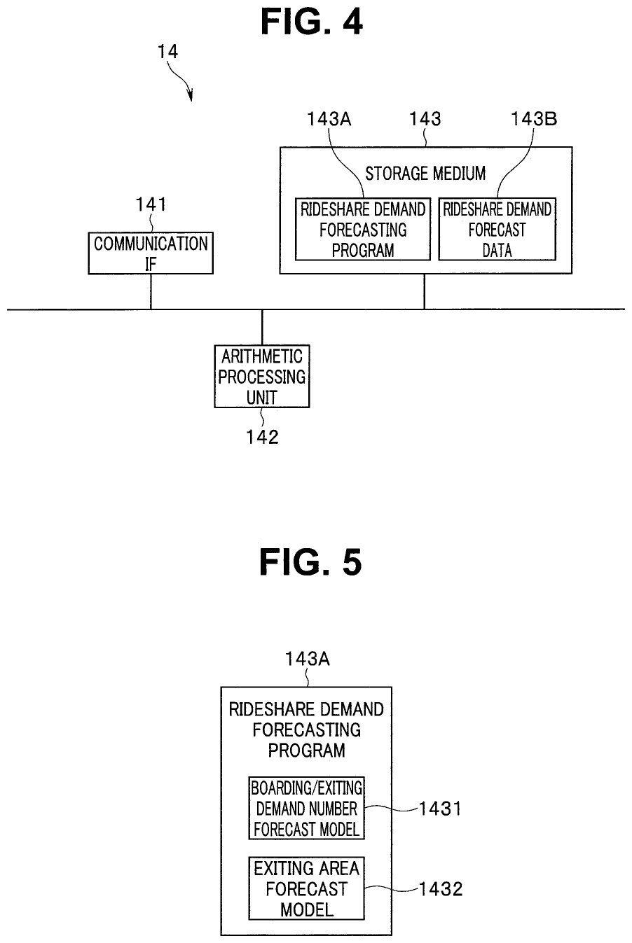

The demand forecasting server 14 is configured to perform processing relating to demand forecasting for the shared taxis 21 based on the reservation data 112A and the accumulated movement data 112B, received from the operation schedule management system 11, and the boarding/exiting factor data 131, received from the boarding/exiting factor data acquisition device 13. In other words, the demand forecasting server 14 is configured as a rideshare vehicle demand forecasting device for forecasting demand for the shared taxis 21 that are operated according to an operation schedule set by reflecting a reservation made by an end user, and that are operated within the plurality of predetermined areas. The demand forecasting server 14 is also configured to send the rideshare demand forecast data 143B, which correspond to the processing result obtained from the above-mentioned processing relating to the demand forecasting, to the operation schedule management system 11 and the information presentation device 15. As shown in FIG. 4, the demand forecasting server 14 is configured to include a communication IF 141, an arithmetic processing unit 142, and a storage medium 143, for example. FIG. 4 is a view showing one example of the configuration of the demand forecasting server according to the embodiment.

For example, the communication IF 141 is configured to include a communication unit that is connectable to a network, such as the Internet, to enable wired or wireless communication with the operation schedule management system 11, the boarding/exiting factor data acquisition device 13, and the information presentation device 15.

The arithmetic processing unit 142 is configured to include a CPU and a GPU (graphics processing unit), for example, to perform processing relating to the demand forecasting for the shared taxis 21 by using the reservation data 112A and the accumulated movement data 112B received from the operation schedule management system 11, the boarding/exiting factor data 131 received from the boarding/exiting factor data acquisition device 13, and a rideshare demand forecasting program 143A (described later) read from the storage medium 143. In other words, the arithmetic processing unit 142 is configured to include one or more processors. The arithmetic processing unit 142 is also configured to perform an action for causing the rideshare demand forecast data 143B acquired by performing the above-mentioned processing relating to the demand forecasting to be stored in the storage medium 143. The arithmetic processing unit 142 is also configured to perform an action for causing the rideshare demand forecast data 143B acquired by performing the above-mentioned processing relating to the demand forecasting to be sent from the communication IF 141 to the operation schedule management system 11 and the information presentation device 15. The arithmetic processing unit 142 is also configured to perform an action for causing the reservation data 112A used at the time of acquiring the rideshare demand forecast data 143B to be sent from the communication IF 141 to the information presentation device 15.

The storage medium 143 is configured to include, for example, non-transitory computer readable medium, such as a nonvolatile memory. Further, the rideshare demand forecasting program 143A and the rideshare demand forecast data 143B are stored in the storage medium 143.

As shown in FIG. 5, the rideshare demand forecasting program 143A is configured to include a boarding/exiting demand number forecast model 1431 and an exiting area forecast model 1432, for example. FIG. 5 is a view for describing one example of the configuration of the rideshare demand forecasting program used in the processing of the demand forecasting server according to the embodiment.

The boarding/exiting demand number forecast model 1431 is configured as a hierarchical neural network that uses a deep autoencoder, for example, and is configured as a model that is caused to learn parameters used in processing of each node included in the neural network by deep learning (machine learning). The boarding/exiting demand number forecast model 1431 is also configured to perform processing that uses, as input data, the reservation data 112A and the accumulated movement data 112B received from the operation schedule management system 11, and the boarding/exiting factor data 131 received from the boarding/exiting factor data acquisition device 13 to enable the acquisition of the reservation forecast number RFN as output data. The reservation forecast number RFN corresponds to the number of reservations capable of being established in the future as reservations for boarding/exiting the taxis 21 within the plurality of predetermined areas included in the operation area of the shared taxis 21.

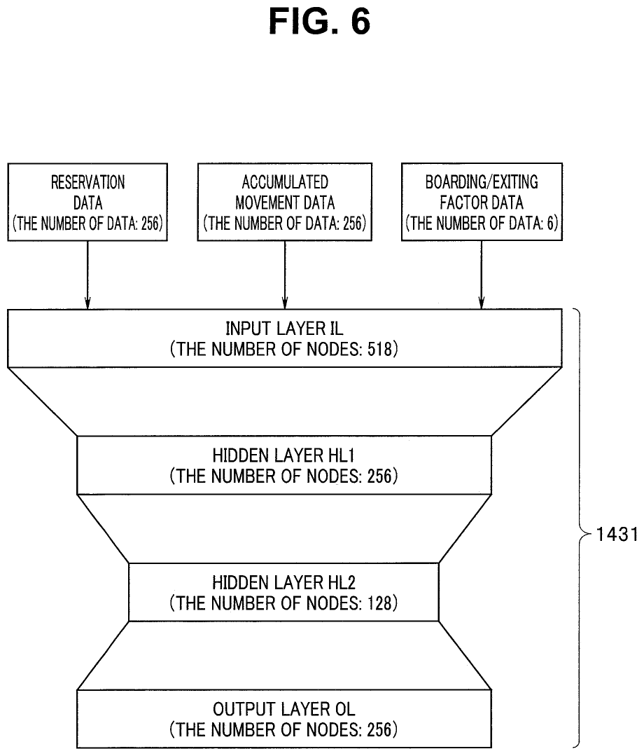

More specifically, for example, as shown in FIG. 6, the boarding/exiting demand number forecast model 1431 has an input layer IL having 518 nodes for individually receiving, as inputs, 256 pieces of data contained in the matrix data MDA of the reservation data 112A (see FIG. 2), 256 pieces of data contained in the matrix data MDB of the accumulated movement data 112B (see FIG. 3), and 6 pieces of data contained in weather data, temperature data, and date data of the boarding/exiting factor data 131. For example, as shown in FIG. 6, the boarding/exiting demand number forecast model 1431 also has a hidden layer HL1, a hidden layer HL2, and an output layer OL. The hidden layer HL1 includes 256 nodes for performing parallel processing of data outputted from the input layer IL. The hidden layer HL2 includes 128 nodes for performing parallel processing of data outputted from the hidden layer HL1. The output layer OL includes 256 nodes for acquiring the output result by performing parallel processing of data outputted from the hidden layer HL2. FIG. 6 is a conceptual view for describing one example of the boarding/exiting demand number forecast model contained in the rideshare demand forecasting program.

In other words, the boarding/exiting demand number forecast model 1431 exemplified in FIG. 6 performs the processing that uses, as input data, 256 pieces of data contained in the matrix data MDA of the reservation data 112A, 256 pieces of data contained in the matrix data MDB of the accumulated movement data 112B, and 6 pieces of data contained in weather data, temperature data, and date data of the boarding/exiting factor data 131. Therefore, the boarding/exiting demand number forecast model 1431 can acquire, as output data, the reservation forecast number RFN capable of being established in the future for each of 256 combinations of the boarding/exiting areas in the above-mentioned sixteen areas of the area AR1 to the area AR16.

According to the present embodiment, for the learning for the boarding/exiting demand number forecast model 1431, it is sufficient to perform learning by a method that varies parameters used in the processing of each node included in the neural network of the boarding/exiting demand number forecast model 1431 by using, as input data, past reservation data 112A (matrix data MDA), past accumulated movement data 112B (matrix data MDB), and past boarding/exiting factor data 131 acquired before the day before the operation of the shared taxis 21, for example. With such a learning method, it is possible to form a model where the reservation forecast number RFN approximates the number of reservations actually established in each area included in the operation area of the shared taxis 21.

The exiting area forecast model 1432 is configured as a hierarchical neural network, for example, and is configured as a model that is caused to learn parameters used in the processing of each node included in the neural network by deep learning (machine learning). The exiting area forecast model 1432 is also configured to receive, as input data, feature values FV each of which is calculated for each area included in the operation area of the shared taxis 21 by using, for example, at least one of data relating to movement distances of the shared taxis 21, data relating to the kind (category) of boarding/exiting point present in the plurality of predetermined areas included in the operation area of the shared taxis 21, or data relating to the profiles of end users who utilize the shared taxis 21.

In the calculation of the feature value FV, for example, data obtained by aggregating accumulated movement distances of the shared taxis 21 in the operation area for respective operation days may be used as data relating to the movement distances of the shared taxis 21. Further, it is sufficient that data relating to the movement distances of the shared taxis 21 are contained in the accumulated movement data 112B, for example.

In the calculation of the feature value FV, for example, data where each point contained in map data for the operation area of the shared taxis 21 is classified into at least one of a plurality of categories, such as “residential area”, “station” or “commercial facility” may be used as data relating to the kind (category) of boarding/exiting point of the shared taxi 21. Further, it is sufficient that the data relating to the kind (category) of boarding/exiting point of the shared taxi 21 can be acquired with map data for the operation area of the shared taxis 21, for example.

In the calculation of the feature value FV, arbitrary data contained in user registration information in the taxi reservation site may be used as data relating to the profiles of end users who utilize the shared taxis 21. More specifically, in the calculation of the feature value FV, for example, data where the maximum age, the minimum age, the average age, the number of men, and the number of women for end users at the time of the establishment of a reservation for the shared taxis 21 are aggregated for each area included in the operation area of the shared taxis 21 may be used as data relating to the profiles of the end users who utilize the shared taxis 21. Further, it is sufficient that the data relating to the profiles of end users who utilize the shared taxis 21 are contained in the reservation data 112A, for example.

In the present embodiment, for example, the arithmetic processing unit 142 may calculate the feature value FV. Alternatively, the arithmetic processing unit 142 may acquire the feature value FV calculated by the schedule processing unit 111.

The exiting area forecast model 1432 is configured to be able to acquire, as output data, exiting likelihood ELH, which corresponds to the probability of an occurrence of exiting in each of the plurality of predetermined areas included in the operation area of the shared taxis 21, in response to an input of the feature value FV corresponding to input data.

According to the present embodiment, the weight of each data used in calculating the feature value FV is adjusted on the operation day of the shared taxis 21, and the exiting area forecast model 1432 is caused to repeatedly perform learning by using, as input data, the feature value FV calculated for each area included in the operation area of the shared taxis 21 by using the adjusted weight. The above-mentioned work is performed every day (periodically). With such work, for example, parameters used in the processing of each node included in the neural network of the exiting area forecast model 1432 can be changed every day (periodically) and hence, it is possible to acquire the exiting likelihood ELH corresponding to the change of demand that may occur in the operation area of the shared taxis 21.

In other words, the arithmetic processing unit 142 is configured to perform processing relating to the demand forecasting for the shared taxis 21 by using the rideshare demand forecasting program 143A (described later), read from the storage medium 143, to acquire the reservation forecast number RFN that corresponds to output data from the boarding/exiting demand number forecast model 1431, and the exiting likelihood ELH that corresponds to output data from the exiting area forecast model 1432 as the rideshare demand forecast data 143B.

The arithmetic processing unit 142 is also configured to have a function as a reservation forecast number acquisition unit to acquire the reservation forecast number, which corresponds to the number of reservations capable of being established in the future as reservations for boarding/exiting the shared taxi 21 within the plurality of predetermined areas included in the operation area of the shared taxis 21, at predetermined intervals by using the boarding/exiting demand number forecast model 1431. The boarding/exiting demand number forecast model 1431 includes a neural network that is caused to perform machine learning by using, as input data, the reservation data 112A indicating a reservation situation at the time of establishment of the reservation for the shared taxis 21, the accumulated movement data 112B indicating an area where an end user actually boards/exits the shared taxi 21 on the operation day of the shared taxis 21, and the boarding/exiting factor data 131 containing data that are capable of becoming a factor for an occurrence of the boarding/exiting of an end user on the operation day of the shared taxis 21.

The arithmetic processing unit 142 is also configured to have a function as an exiting likelihood acquisition unit to acquire exiting likelihood, which corresponds to the probability of an occurrence of exiting in the future in each of the plurality of predetermined areas, at predetermined intervals by using the exiting area forecast model 1432. The exiting area forecast model 1432 includes a neural network that is caused to perform machine learning by using, as input data, the feature value FV calculated by using at least one of data relating to the movement distances of the shared taxis 21, data relating to the kind of boarding/exiting points present in the plurality of predetermined areas included in the operation area of the shared taxis 21, or data relating to the profiles of end users who utilize the shared taxis 21.

In the present embodiment, it is sufficient that the rideshare demand forecasting program 143A including the boarding/exiting demand number forecast model 1431 and the exiting area forecast model 1432 is stored in computer readable storage medium. Examples of computer readable storage medium may be an optical disk, such as a CD-ROM, a phase change type optical disk, such as a DVD-ROM, a magneto-optical disk, such as an MO (magnet optical) and an MD (mini disk), a magnetic disk, such as a floppy (registered trademark) disk and a removable hard disk, and a memory card, such as a compact flash (registered trademark), a smart media, an SD memory card, and a memory stick. A hardware device, such as an integrated circuit (IC chip or the like) that is specially designed for the purpose of the present invention is also included in the storage medium.

The information presentation device 15 is configured to include a processor, a memory, a communication unit, and a monitor, for example.

The information presentation device 15 is configured to perform processing for displaying a demand forecast screen during a period when predetermined software, for example, is activated. The demand forecast screen is obtained by synthesizing map data for the operation area of the shared taxis 21 and information obtained based on the reservation data 112A and the rideshare demand forecast data 143B received from the demand forecasting server 14. The specific example of the above-mentioned demand forecast screen will be described later.

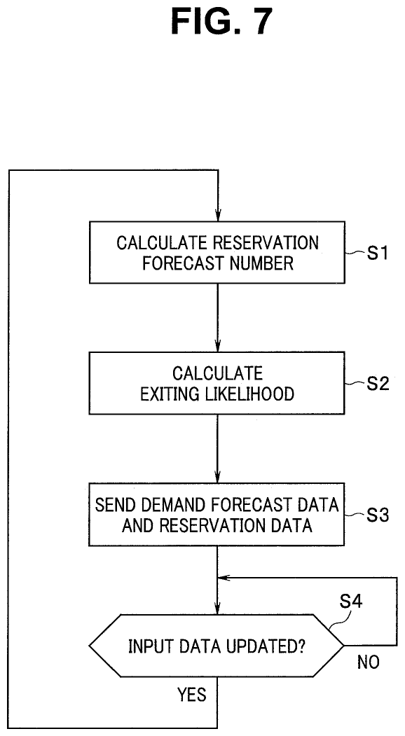

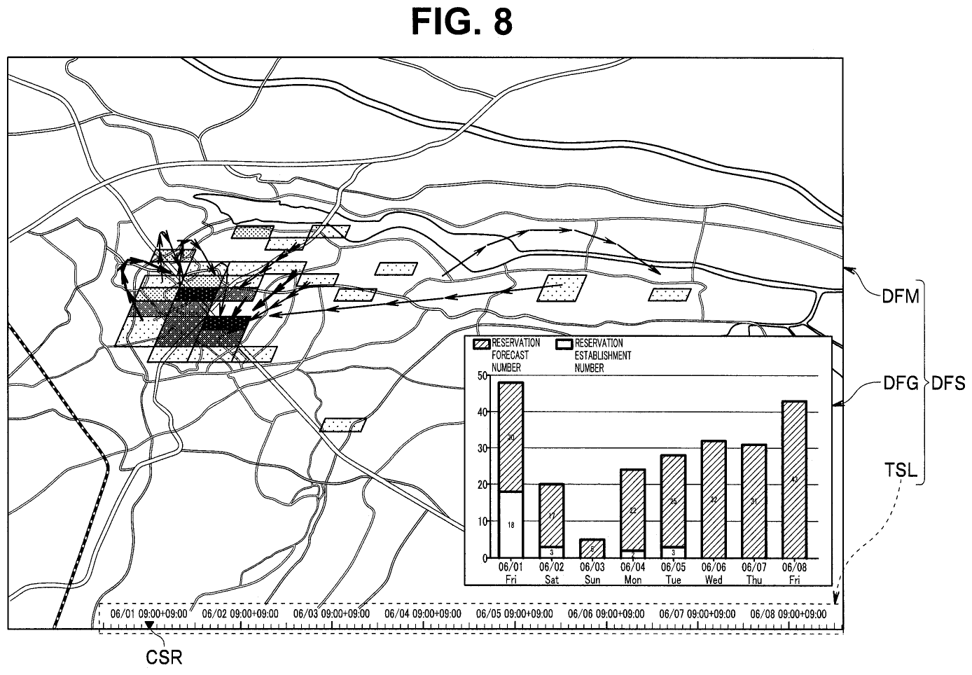

Subsequently, the manner of operation of the present embodiment will be described with reference to FIG. 7 and FIG. 8. FIG. 7 is a flowchart showing one example of processing performed by the demand forecasting server according to the embodiment. FIG. 8 is a view for describing a specific example of the demand forecast screen.

The schedule processing unit 111 performs processing for generating reservation management information each time a reservation made by an end user is established, and performs processing for updating the reservation data 112A (matrix data MDA) by using the generated reservation management information. At the same time, the schedule processing unit 111 performs an action for causing the updated reservation data 112A to be sent from the communication IF 113 to the demand forecasting server 14 at predetermined intervals (at five-minute intervals, for example).

The schedule processing unit 111 performs processing for generating operation management information on the operation day of the shared taxis 21 each time boarding/exiting of a passenger occurs, and performs processing for updating the accumulated movement data 112B (matrix data MDB) by using the generated operation management information. At the same time, the schedule processing unit 111 performs an action for causing the updated accumulated movement data 112B to be sent from the communication IF 113 to the demand forecasting server 14 at predetermined intervals (at five-minute intervals, for example).

The boarding/exiting factor data acquisition device 13 acquires the boarding/exiting factor data 131 at arbitrary timing, and sends the acquired boarding/exiting factor data 131 to the demand forecasting server 14 at predetermined intervals (at five-minute intervals, for example).

The arithmetic processing unit 142 performs processing by using, as input data for the boarding/exiting demand number forecast model 1431, the matrix data MDA contained in the reservation data 112A received from the operation schedule management system 11, the matrix data MDB contained in the accumulated movement data 112B received from the operation schedule management system 11, and the boarding/exiting factor data 131 received from the boarding/exiting factor data acquisition device 13, thus acquiring the reservation forecast number RFN (step S1 in FIG. 7).

The arithmetic processing unit 142 performs processing for calculating the feature value FV for each area included in the operation area of the shared taxis 21 by using data relating to the movement distances of the shared taxis 21, data relating to the kind (category) of boarding/exiting point of the shared taxi 21, and data relating to the profiles of end users who utilize the shared taxis 21. The arithmetic processing unit 142 also performs processing by using, as input data for the exiting area forecast model 1432, the feature value FV calculated for each area included in the operation area of the shared taxis 21, thus acquiring exiting likelihood ELH (step S2 in FIG. 7).

The arithmetic processing unit 142 acquires the reservation forecast number RFN acquired by the processing of step S1 in FIG. 7 and the exiting likelihood ELH acquired by the processing of step S2 in FIG. 7 as the rideshare demand forecast data 143B, and performs an action for causing the acquired rideshare demand forecast data 143B to be sent from the communication IF 141 to the operation schedule management system 11 and the information presentation device 15 at predetermined intervals (at five-minute intervals, for example) (step S3 in FIG. 7). Further, the arithmetic processing unit 142 performs an action for causing the reservation data 112A used at the time of acquiring the rideshare demand forecast data 143B to be sent from the communication IF 141 to the information presentation device 15 at predetermined intervals (at five-minute intervals, for example) (step S3 in FIG. 7).

The arithmetic processing unit 142 performs processing for judging whether or not at least either one of the input data for the boarding/exiting demand number forecast model 1431 used in the processing of step S1 in FIG. 7 or the input data for the exiting area forecast model 1432 used in the processing of step S2 in FIG. 7 is updated (step S4 in FIG. 7).

When the arithmetic processing unit 142 acquires the judgement result that neither the input data for the boarding/exiting demand number forecast model 1431 nor the input data for the exiting area forecast model 1432 is updated (S4: NO), the processing of step S4 in FIG. 7 is repeatedly performed.

When the arithmetic processing unit 142 acquires the judgement result that at least either one of the input data for the boarding/exiting demand number forecast model 1431 or the input data for the exiting area forecast model 1432 is updated (S4: YES), the processing from step S1 in FIG. 7 is performed again.

With the above-mentioned processing performed by the arithmetic processing unit 142, it is possible to acquire the rideshare demand forecast data 143B containing the reservation forecast number RFN and the exiting likelihood ELH from the operation day of the shared taxis 21 to a day several weeks later, for example. Further, with the above-mentioned processing performed by the arithmetic processing unit 142, it is possible to acquire the rideshare demand forecast data 143B corresponding to input data (the reservation data 112A, the accumulated movement data 112B, and the boarding/exiting factor data 131) updated at five-minute intervals, for example.

During a period when predetermined software is activated, the information presentation device 15 performs processing for displaying the demand forecast screen obtained by synthesizing map data for the operation area of the shared taxis 21 and information obtained based on the reservation data 112A and the rideshare demand forecast data 143B received from the demand forecasting server 14. With such processing, for example, a demand forecast screen DFS shown in FIG. 8 is displayed on a display device, such as a monitor.

As shown in FIG. 8, the demand forecast screen DFS is configured as a screen that includes a demand forecast map DFM, a demand forecast graph DFG, and a time slider TSL.

For example, the demand forecast map DFM is formed by making a heat map corresponding to the reservation forecast number RFN, contained in the rideshare demand forecast data 143B, and arrows corresponding to the exiting likelihood ELH, contained in the rideshare demand forecast data 143B, overlap on the map data for the operation area of the shared taxis 21.

In the heat map contained in the demand forecast map DFM, of the respective areas included in the operation area of the shared taxis 21, areas where the reservation forecast number RFN is equal to or more than a predetermined number are colored with a predetermined color. Further, the heat map contained in the demand forecast map DFM is drawn such that the greater the reservation forecast number RFN, the higher the density of a predetermined color becomes. In the heat map contained in the demand forecast map DFM exemplified in FIG. 8, each area included in the operation area of the shared taxis 21 is indicated by a quadrangular shape. Further, in the heat map contained in the demand forecast map DFM exemplified in FIG. 8, for the sake of convenience of illustration, thick hatching patterns are applied to areas where the reservation forecast number RFN is great, and thin hatching patterns are applied to areas where the reservation forecast number RFN is low.

In other words, in step S1 and step S3 in FIG. 7, the arithmetic processing unit 142 performs processing for acquiring data for causing a heat map to be drawn, the heat map showing the level of the reservation forecast number RFN in each of the plurality of predetermined areas included in the operation area of the shared taxis 21, and the arithmetic processing unit 142 performs an action for causing the acquired data to be sent to the information presentation device 15 at predetermined intervals.

The arrows included in the demand forecast map DFM indicate the movements of the shared taxis 21 from at least one boarding area of the respective areas included in the operation area of the shared taxis 21 to an exiting area where the exiting likelihood ELH is equal to or more than a predetermined value. Further, the arrows included in the demand forecast map DFM are drawn with a thickness corresponding to the degree of the exiting likelihood ELH.

In other words, in step S2 and step S3 in FIG. 7, the arithmetic processing unit 142 performs processing for acquiring data for causing the symbols to be drawn, the symbols indicating the movements from at least one boarding area of the plurality of predetermined areas included in the operation area of the shared taxis 21 to the exiting area where the exiting likelihood ELH is equal to or more than a predetermined value, and the arithmetic processing unit 142 performs an action for causing the acquired data to be sent to the information presentation device 15 at predetermined intervals.

The demand forecast graph DFG is drawn as a bar graph showing the correspondence between a reservation establishment number REN corresponding to the number of reservations actually established that is acquired based on the reservation data 112A and the reservation forecast number RFN contained in the rideshare demand forecast data 143B for each date. The demand forecast graph DFG exemplified in FIG. 8 allows the confirmation of the correspondence between the reservation establishment number REN and the reservation forecast number RFN for eight days.

The time slider TSL is provided with a cursor CSR configured as GUI that can be moved along a time axis with graduations, and that is capable of giving instructions for causing demand forecast on a desired date and time after the operation day of the shared taxis 21 to be displayed. With such a configuration of the time slider TSL, it is possible to bring, according to the position of the cursor CSR on the time axis with graduations, the drawing state of the heat map and the arrows contained in the demand forecast map DFM into a drawing state corresponding to demand forecast on a desired date and time after the operation day of the shared taxis 21. The time slider TSL exemplified in FIG. 8 can display demand forecast on a desired date and time out of eight days from the operation day of the shared taxis 21 according to the position of the cursor CSR on the time axis with graduations.

As described above, according to the present embodiment, it is possible to acquire the rideshare demand forecast data 143B containing the reservation forecast number RFN and the exiting likelihood ELH, and to make the operation schedule of the shared taxis 21 based on the rideshare demand forecast data 143B. Further, as described above, according to the present embodiment, for example, a manager belonging to the management organization of the shared taxis 21 confirms the demand forecast screen DFS displayed according to the reservation data 112A and the rideshare demand forecast data 143B, so that the number of shared taxis 21 operated on the desired date after the operation day of the shared taxis 21 can be adjusted to an appropriate number. Therefore, according to the present embodiment, it is possible to keep a departure/arrival time decided in advance, and to forecast demand with high accuracy for efficiently dispatching rideshare vehicles.

The configuration according to the present embodiment may be suitably modified to be applied to demand forecasting for rideshare vehicles operated in a predetermined facility, such as a factory. Further, an operation schedule set by reflecting a reservation made by an end user also includes a case where an operation schedule is not made without a reservation made by an end user (an operation schedule is set according to a reservation made by an end user), and a case where an operation schedule is roughly decided in advance, and the operation schedule is corrected according to a reservation made by an end user. The shared taxi 21 as a rideshare vehicle includes not only a so-called “taxi” but also a mode referred to as “bus”.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rideshare vehicle demand forecasting device for forecasting demand for a rideshare vehicle that is operated according to an operation schedule set by reflecting a reservation made by an end user, and that is operated within a plurality of predetermined areas, the rideshare vehicle demand forecasting device comprising
a processor, wherein
the processor is configured to acquire a reservation forecast number, which corresponds to a number of reservations each of which is capable of being established in future as a reservation for boarding/exiting the rideshare vehicle within the plurality of predetermined areas, at predetermined intervals by using a model including a neural network that is caused to perform machine learning by using, as input data, reservation data indicating a reservation situation at a time of establishment of the reservation for the rideshare vehicle, movement data indicating an area where the end user actually boards/exits the rideshare vehicle on an operation day of the rideshare vehicle, and boarding/exiting factor data containing data that are capable of becoming a factor for an occurrence of boarding/exiting of the end user on the operation day of the rideshare vehicle.

2. The rideshare vehicle demand forecasting device according to claim 1, wherein
the processor is configured to acquire data for causing a heat map to be drawn, the heat map showing a level of the reservation forecast number in each of the plurality of predetermined areas, and to perform an action for causing the data acquired to be sent to an information presentation device at the predetermined intervals.

3. The rideshare vehicle demand forecasting device according to claim 1, wherein
the boarding/exiting factor data contain data indicating weather in the plurality of predetermined areas, data indicating temperatures of the plurality of predetermined areas, and data indicating a date of the operation day of the rideshare vehicle.

4. The rideshare vehicle demand forecasting device according to claim 1, wherein
the processor further acquires exiting likelihood, which corresponds to a probability of an occurrence of exiting in future in each of the plurality of predetermined areas, at the predetermined intervals by using a model including a neural network that is caused to perform machine learning by using, as input data, a feature value calculated by using at least one of data relating to a movement distance of the rideshare vehicle, data relating to a kind of boarding/exiting point present in the plurality of predetermined areas, or data relating to a profile of the end user who utilizes the rideshare vehicle.

5. The rideshare vehicle demand forecasting device according to claim 1, wherein
the processor acquires data for causing a symbol to be drawn, the symbol indicating movement from at least one boarding area of the plurality of predetermined areas to an exiting area where the exiting likelihood is equal to or more than a predetermined value, and the processor performs an action for causing the data acquired to be sent to an information presentation device at the predetermined intervals.

6. A method for forecasting demand for a rideshare vehicle in order to forecast the demand for the rideshare vehicle that is operated according to an operation schedule set by reflecting a reservation made by an end user, and that is operated within a plurality of predetermined areas, the method comprising
acquiring a reservation forecast number, which corresponds to a number of reservations each of which is capable of being established in future as a reservation for boarding/exiting the rideshare vehicle within the plurality of predetermined areas, at predetermined intervals by using a model including a neural network that is caused to perform machine learning by using, as input data, reservation data indicating a reservation situation at a time of establishment of the reservation for the rideshare vehicle, movement data indicating an area where the end user actually boards/exits the rideshare vehicle on an operation day of the rideshare vehicle, and boarding/exiting factor data containing data that are capable of becoming a factor for an occurrence of boarding/exiting of the end user on the operation day of the rideshare vehicle.

7. A computer readable non-transitory storage medium recording a program performed by a computer for forecasting demand for a rideshare vehicle operated according to an operation schedule set by reflecting a reservation made by an end user, and operated within a plurality of predetermined areas, the storage medium comprising
a program for causing processing for acquiring a reservation forecast number, which corresponds to a number of reservations each of which is capable of being established in future as a reservation for boarding/exiting the rideshare vehicle within the plurality of predetermined areas, at predetermined intervals by using a model including a neural network that is caused to perform machine learning by using, as input data, reservation data indicating a reservation situation at a time of establishment of the reservation for the rideshare vehicle, movement data indicating an area where the end user actually boards/exits the rideshare vehicle on an operation day of the rideshare vehicle, and boarding/exiting factor data containing data that are capable of becoming a factor for an occurrence of boarding/exiting of the end user on the operation day of the rideshare vehicle.
